(19) United States
(12) Patent Application Publication
(10) Pub. No.: US 2021/0323531 A1
(43) Pub. Date: Oct. 21, 2021

(54) ELECTRONIC BRAKE SYSTEM

(71) Applicant: WABCO GMBH, Hannover (DE)

(72) Inventors: Rainer RISSE, Pattensen-Reden (DE); Axel STENDER, Hameln (DE); Norbert WITTE, Lauenau (DE)

(21) Appl. No.: 17/270,251

(22) PCT Filed: Jun. 28, 2019
(86) PCT No.: PCT/EP2019/067282

§ 371 Date: Feb. 22, 2021

(30) Foreign Application Priority Data
Aug. 22, 2018 (DE) 10 2018 120 477.9

(51) Int. Cl. B60T 17/22; F16D 66/02

(52) U.S. Cl. CPC B60T 17/221; B60T 2240/03; F16D 66/027

(57) ABSTRACT

An electronic brake system for a vehicle has an electronic control device and wear sensors on brakes. In the electronic brake system, signals of the wear sensors are transmitted in a wireless fashion to the control device or to a receiver which is connected to the control device.

### CROSS-REFERENCE TO RELATED APPLICATIONS

This application is the National Stage of International Application No. PCT/EP2019/067282, filed on 28 Jun. 2019, which claims priority to and all advantages of German Patent Application No. 10 2018 120 477.9, filed on 22 Aug. 2018, the contents of which are hereby incorporated by reference.

### FIELD OF THE DISCLOSURE

The invention relates to an electronic brake system for a vehicle, having an electronic control device and wear sensors on brakes. In particular, the electronic brake system in question is for trailer vehicles, preferably with a pneumatic brake system. However, the invention can also be advantageously used in conjunction with tractor vehicles and/or other brake systems. In addition, the invention relates to a control device for an electronic brake system.

### BACKGROUND

It is known to use wear sensors on brakes and to transmit wear signals to a brake control device via a vehicle-internal bus system, see EP 2 439 117 B1. The cabling which is necessary for this excludes the retrofitting of vehicles. The expenditure would be too high. For wireless transmission of the wear signals, the brake control device would have to be additionally equipped with a suitable receiver.

Modern vehicles are equipped with a tyre pressure monitoring system (TPMS). Each tyre has a pressure sensor and a transmitter which transmits in a standardized format (TPMS format) to a receiver in the vehicle. The vehicle electronics can evaluate the received signals and, for example, display warning messages to the driver. WO 2016/058679 A1 discloses integrating a tyre pressure monitoring module, which receives signals from tyre pressure sensors, to into a so-called modulator for the electronic brake system. The modulator also has the control device.

The object of the present invention is to provide an electronic brake system which has a control device and wear sensors and which is, in particular, advantageously suitable for retrofitting.

### BRIEF SUMMARY

An electronic brake system for a vehicle is disclosed. The electronic brake system has an electronic control device and wear sensors on brakes, wherein signals of the wear sensors are transmitted in a wireless fashion to the control device or to a receiver which is connected to the control device. Transmitters and receivers of a simple type are cost effective to acquire and to use. Retrofitting can therefore be implemented at relatively low cost.

According to a further concept of the invention, the control device can have a receiver for wireless signals of tyre pressure sensors of a tyre pressure monitoring system or can be connected to such a receiver, wherein the wear sensors have transmitters for the wireless transmission of signals of the wear sensors in the format of the signals of tyre pressure sensors or are connected to such transmitters. In particular, the transmitters transmit their signals in the known TPMS format of tyre pressure monitoring systems. Control devices with suitable receivers already exist.

According to a further concept of the invention, the wear sensors can measure the total wear of brake linings which act on brake disks. In this way, the distance between the brake lining carriers can be determined. The thickness of an individual brake lining is therefore not measured itself but rather is included indirectly in the measurement.

According to a further concept of the invention there can be provision that the wear sensors output a signal which is proportional to the wear of brake linings. In this context this can also be the total wear.

According to a further concept of the invention there can be provision that signals which are in particular simultaneous or occur within a defined time period, of the wear sensors of various brakes, are compared with one another. In this way, deviations between the brakes can be detected, for example stuck brake cylinders.

According to a further concept of the invention there can be provision that signals of the wear sensors are transmitted before, during and/or after a braking operation. By combining and/or comparing the signals it is possible to acquire knowledge which has previously not been possible. It may also be appropriate to transmit signals only after a braking operation, for example in order to save energy. A maximum wear signal can also be determined and transmitted during a braking operation. The level of the wear signal is also dependent on the brake pressure.

According to a further concept of the invention there may be provision that from the difference between the signals before and after the braking operation, it is evaluated whether the brake has reset again into an initial position. In this way, a brake which is sticking, with the risk of overheating, can be detected.

According to a further concept of the invention there can be provision that activation of the brakes is used to evaluate the signals. An electronic brake signal is triggered in the electronic brake system by actuating a brake pedal. The control device receives the brake signal and actuates electromagnetic valves for the actuation of the brake cylinders correspondingly. There can therefore be provision that wear signals of the wear sensors are evaluated only after activation of the brakes, that is to say during or after brake signals which are present. In this way, the last signals which are transmitted before the activation of the brakes can therefore be identified and evaluated, for example in conjunction with the signals which are transmitted during and/or after the activation of the brakes.

According to a further concept of the invention there can be provision that from the difference between the maximum signal and a signal before and/or after a braking operation it is evaluated whether the brakes are functional. For example it can therefore be determined whether the resetting of the brakes is functioning or whether a brake is running into so-called fading.

According to a further concept of the invention there can be provision that the wear sensors output a signal which is proportional to the position of a sensing rod. This can also be the total wear here.

According to a further concept of the invention there may be provision that the wear sensor contains a sensing rod which is connected by one end with a brake lining carrier, in particular on a specific side of the brake, or bears there, and that a position of another end of the sensing rod can be detected by a sensor element. The sensor element is preferably connected to the other brake lining carrier on the opposite side of the brake or bears there. For example, the sensor element includes a Hall sensor, while the sensing rod has a magnet which is detected by the Hall sensor. The sensor element and end of the sensing rod do not have to be directly connected to the brake lining carrier, or bear there. A connection to or bearing against components which are connected to the brake lining carriers is also sufficient. It will also be possible to detect, at least indirectly, the distance between the two brake lining carriers.

Where the term wear sensor is used here, reference is preferably made to an indeterminate number, including the possibility of just one wear sensor. However, all the brakes are advantageously equipped with wear sensors.

The subject matter of the invention is also a control device for an electronic brake system, with software for evaluating wireless signals of wear sensors on brakes. Furthermore, the subject matter of the invention is also a vehicle with the electronic brake system.

### BRIEF DESCRIPTION OF DRAWINGS

The foregoing aspects and many of the attendant advantages will become more readily appreciated as the same becomes better understood by reference to the following detailed description, when taken in conjunction with the accompanying drawings, wherein like reference numerals refer to like parts throughout the various views, unless otherwise specified:

FIG. 1 shows a schematic illustration of an electronic brake system of a trailer vehicle having three axles,

FIG. 2 shows a wheel brake without a brake pressure applied, and

FIG. 3 shows a wheel brake with a brake pressure applied.

### DETAILED DESCRIPTION

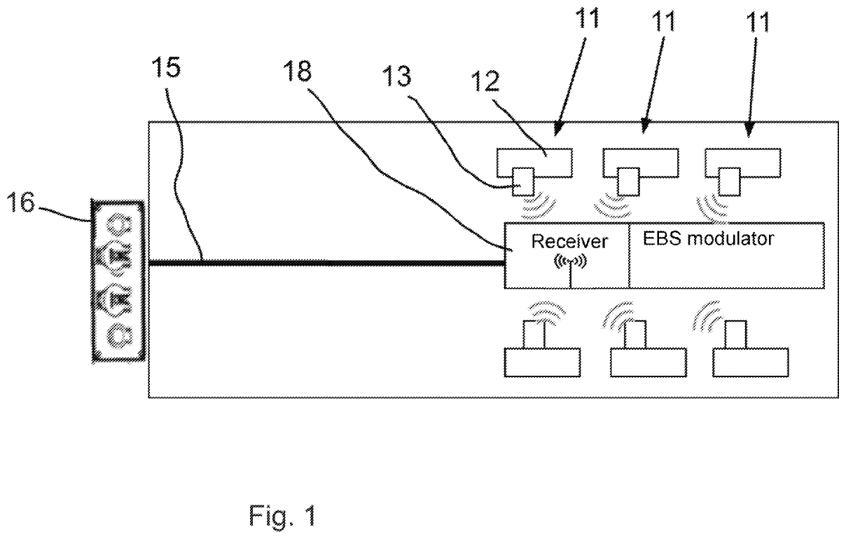

According to FIG. 1, a trailer 10 is equipped with six wheels 11 on three axles. Each wheel 11 has a brake 12 with a wear sensor 13.

The trailer 10 is equipped with a pneumatic brake system and an electronic brake system (EBS). The latter has what is referred to as an EBS modulator 14 in which a brake control device and solenoid valves or pneumatic components for actuating the brakes 12 are combined in a known fashion. The brake control device, which is not shown, is therefore a component of the EBS modulator 14.

The EBS modulator 14 is connected to corresponding lines of a tractor vehicle (not shown) via pneumatic and electrical lines 15 and suitable interfaces, combined here as interface 16. In addition, the trailer 10 has customary components (not shown) of pneumatic brake equipment with an electronic brake system.

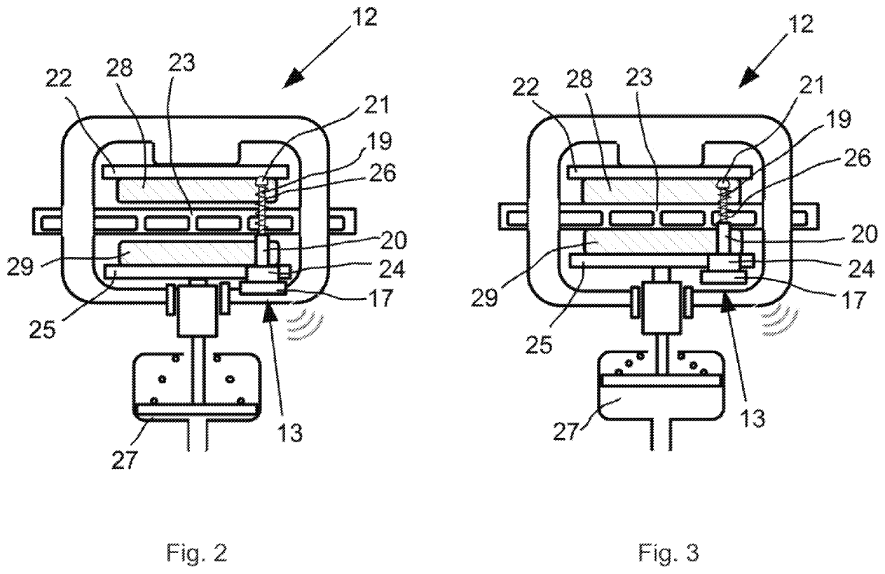

The wear sensor 13 is assigned a radio module 17 as a transmitter. The radio module 17 is either integrated into the wear sensor 13 or can only be exchanged therewith, see FIGS. 2 and 3, or else is connected to the wear sensor 13. A component of the radio module 17 is a stand-alone power supply, for example by means of a long-life battery.

The EBS modulator 14 is assigned a radio module 18 as a receiver, referred to as receiver in FIG. 1. The radio module 18 communicates with the radio module 17 and is integrated into the EBS modulator 14, integrated into the control device (not shown) or connected to one of these two components so that signals which are picked up by radio module 18 can be processed in the control device.

The radio modules 17, 18 communicate here preferably in the same format and using the same standard of the known tyre pressure monitoring systems, that is to say in the TPMS format. For relatively new vehicles, tyre pressure sensors and the transmission of the tyre pressure by radio to a control device are prescribed in any case. Corresponding control devices with radio modules for the reception of the signals from tyre pressure monitoring sensors are known and present in new vehicles. In this case, the communication channel which is present in any case for the signals of the tyre pressure monitoring sensors is used at the same time for the reception of signals of the wear sensors 13.

The wear sensors 13 are constructed in a known fashion. A mechanical sensing rod 19 is installed in a holder 20 and bears with a head 21 against an outer lining carrier 22 and is oriented perpendicularly to the plane of a brake disk 23 here.

A sensor element 24 of the wear sensor 13 and/or the holder 20 are securely connected to an inner lining carrier 25, in particular in a detachable and exchangeable fashion. The sensing rod 19 has a restoring element, in particular a compression spring 26, so that the head 21 always bears against the outer lining carrier 22, irrespective of the distance between the lining carriers 22, 25. The sensor element 24 detects the position of the sensing rod 19 in the holder 20 and is, in particular a Hall sensor. For this purpose, the sensing rod 19 is provided with a magnet.

When there is no brake pressure, that is to say when the brake cylinder 27 is not aerated, the line carriers 22, 25 are at a distance from one another, and associated brake linings 28, 29 do not bear against the brake disk 23, see FIG. 2. The sensing rod 19 is extended to the maximum degree from the holder 20.

When there is brake pressure, that is to say when the brake cylinder 27 is aerated, the brake linings 28, 29 come to bear against the brake disk 23, see FIG. 3. The sensing rod 19 then projects further out of the holder 20.

The radio module 17 transmits, with the corresponding signals, the position of the sensing rod 19 to the radio module 18. The position of the sensing rod 19 is a measure for the total wear of the brake linings 28, 29.

The radio modules 17, 18 preferably communicate only in one direction. That is to say the radio module 17 is explicitly the transmitter, and the radio module 18 is exclusively the receiver. Alternatively, both radio modules 17, 18 can be equipped as a transmitter and receiver. As a result, the radio module 18 can radio the radio module 17 assigned to the wear sensor 13 and request it to transmit wear signals.

The radio module 17 preferably sends its signals in the timed fashion, for example every 1 to 10 seconds or every 10 to 60 seconds or even less often. Individual identifiers of the wear sensors 13 are transmitted together with the wear signals, so that the uniquely defined assignment to the respective wheel 11 and to the function as a wear sensor is possible.

The radio modules 17, 18 preferably operate in the high-frequency range, in particular at 433 MHz or 868 MHz and/or are preferably adapted to the frequency of the tyre pressure monitoring system which is present.

The transmission of wear signals by the radio module 17 can also be triggered by the sensor element 24. A transmission process is preferably triggered if a sensing rod 19 has not moved for several seconds and if a movement of the sensing rod 19 has started after a pause. Measurement data can also be stored and transmitted together in the sensor element 24. It is therefore possible, for example, to determine maximum values or minimum values during a braking process and make them available as a data set. The radio module 17 and/or sensor element 24 can be equipped with corresponding control functions.

In the simplest case, the radio module 17 transmits a warning signal when the sensor element 24 determines a limiting value of the sensing rod 19, that is to say particularly deep insertion of the sensing rod 19 into the holder 20.

It is also possible for there to be a correlation of the signals transmitted by the radio module 17 with the activation of the brakes 12. The brake control device in the EBS modulator 14 processes electronic braking commands, and therefore knows the type and time of each braking command and can link the signals which are received before, during and after the activation of the brakes with the evaluation.

### LIST OF REFERENCE NUMBERS (PART OF THE DESCRIPTION)

10 Trailer
11 Wheels
12 Brakes
13 Wear sensor
14 EBS modulator
15 Lines
16 Interface
17 Radio module
18 Radio module (receiver)
19 Sensing rod
20 Holder
21 Head
22 Outer lining carrier
23 Brake disk
24 Sensor element
25 Inner lining carrier
26 Compression spring
27 Brake cylinder
28 Brake lining
29 Brake lining

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. An electronic brake system for a vehicle, having an electronic control device and wear sensors on brakes, wherein signals of the wear sensors are transmitted in a wireless fashion to the control device or to a receiver which is connected to the control device.

2. The electronic brake system as claimed in claim 1, wherein the control device has or is connected to a receiver for wireless signals of tire pressure sensors of a tire pressure-monitoring system and wherein wear sensors have or are connected to transmitters for the wireless transmission of signals of the wear sensors in the format of the signals of tire pressure sensors.

3. The electronic brake system as claimed in claim 1, wherein the wear sensors measure the total wear of brake linings which act on brake disks.

4. The electronic brake system as claimed in claim 1, wherein an output signal of the wear sensors is proportional to the wear of brake linings.

5. The electronic brake system as claimed in claim 1, wherein signals of the wear sensors of different brakes ) are compared with one another.

6. The electronic brake system as claimed in claim 1, wherein signals of the wear sensors are transmitted before, during and/or after a braking operation.

7. The electronic brake system as claimed in claim 1, wherein from a difference between the signals of the wear sensors before and after a braking operation it can be evaluated whether the brake has reset again into an initial position.

8. The electronic brake system as claimed in claim 1, wherein activation of the brakes can be used to evaluate signals of the wear sensors.

9. The electronic brake system as claimed in claim 1, wherein from a difference between a maximum signal and a signal before and/or after a braking operation it can be evaluated whether the brakes are functional.

10. The electronic brake system as claimed in claim 1, wherein the wear sensors output a signal which is proportional to the position of a sensing rod.

11. The electronic brake system as claimed in claim 1, wherein the wear sensor contains a sensing rod which is securely connected by one end to a brake lining carrier or bears there, and in that a position of another end of the sensing rod can be detected by a sensor element.

12. A control device for an electronic brake system as claimed in claim 1 having software for evaluating wireless signals of wear sensors at brakes.

13. A vehicle having an electronic brake system as claimed in claim 1.
